(19) United States
(12) Patent Application Publication
(10) Pub. No.: US 2017/0004725 A1
(43) Pub. Date: Jan. 5, 2017

(54) METHOD FOR IMPLEMENTING INTELLIGENT FLASH CARDS IN MOBILE DEVICE HAVING TOUCH SCREEN, AND MOBILE DEVICE HAVING TOUCH SCREEN FOR IMPLEMENTING INTELLIGENT FLASH CARDS

(71) Applicant: Woo-Jung KIM, SEOUL (KR)

(72) Inventor: Woo-Jung KIM, SEOUL (KR)

(21) Appl. No.: 15/100,300

(22) PCT Filed: Nov. 25, 2014
(86) PCT No.: PCT/KR2014/011371

§ 371 Date: May 28, 2016

(30) Foreign Application Priority Data
Nov. 29, 2013 (KR) 10-2013-0147791
Jul. 18, 2014 (KR) 10-2014-0090750

(51) Int. Cl. G09B 7/08; G09B 19/06; G09B 5/02; G06F 3/0488; G06F 3/0482

(52) U.S. Cl. CPC G09B 7/08; G06F 3/04883; G06F 3/0482; G09B 5/02; G09B 19/06; G06F 3/0485

(57) ABSTRACT

A method for implementing intelligent flash cards in a mobile device having a touch screen includes: displaying cards of a first group in a scrollable scheme on the touch screen, the cards including an identifying element in which the number of times of memorization iteration is visually displayed; detecting a touch event for a first region of a specific card selected among the cards of the first group; comparing the number of times of memorization iteration with the pre-stored reference number of times of completion when the touch event is detected; and excluding the specific card from the first group, changing the specific card into a card of a second group having an attribute distinguished from that of the cards of the first group, and adding the changed card to the second group in the case in which the number of times of the memorization iteration is smaller than the pre-stored reference number of times of the completion, and excluding the specific card from the first group, changing the specific card into a card of a third group having an attribute distinguished from that of the card of the first group and the card of the second group, and adding the changed card to the third group in the case in which the number of times of the memorization iteration is the same as the pre-stored reference number of times of the completion.

### TECHNICAL FIELD

The present invention relates to a method for implementing intelligent flash cards in a mobile device having a touch screen and a mobile device having a touch screen for implementing intelligent flash cards.

### BACKGROUND ART

A mobile device is a portable apparatus that is portable and has one or more of a voice and video call function, and an information input/output function, a data storing function, and the like.

In accordance with diversification of functions, the mobile device has complicated functions such as a photograph or moving picture photographing function, a music or moving picture file reproducing function, a game function, a broadcasting receiving function, and the like. The functions described above are mounted at a time in the mobile device to implement a comprehensive multimedia player.

In order to implement the complicated functions, new various attempts have been conducted in terms of hardware or software in a portable terminal. In addition, a user interface environment for allowing a user to easily and conveniently search or select functions has been provided.

A touch screen that has been prominent as a convenient user interface may implement a display function, which is an output, and a touch function, which is an input, within one device, may easily apply an intuitive layout, a gesture, and the like, and may be usefully utilized to build up a use environment for inputting and outputting or managing data. The mobile device has been combined with an information and communication technology that has been developed to be appropriate for maximizing the advantages of the touch screen described above, and has been mounted with various functions or applications programs to open a smart era.

Meanwhile, since people tend to forget easily, improvement of memory through efficient learning has received attention from before the digital era, and the fact that the following education and learning concepts assist in the improvement of the memory has been accepted without large disagreement.

Distributed iteration: after initial learning, iteration is necessary, and should be performed at periodical time differences that have become gradually large rather than being simultaneously performed several times.

Testing effect: an attention concentration of a learner is increased when contents that need to be memorized are presented to the learner in a state in which the contents partially are hidden rather than being entirely shown to the learner.

Classification effect: attention concentration of a learner is increased when an option is provided to the learner to allow the learner to classify items into items that he/she knows and items that he/she does not know, rather than allowing the learner to passively see sequentially all items to be memorized.

Index presentation: An entire amount to be learned and an amount currently learned by a learner in the entire amount to be learned are clearly notified as indices to the learner to motivate the learner to complete memorization.

There are the following technologies with respect to a learning program or application for improving the memory that may be applied to a mobile device such as a smart phone, a smart pad, or the like.

(1) Analog Card Learning

A question or a hint (for example, a drawing, or the like) is written on a front surface of a card, and an answer is written on a rear surface of the card to promote a testing effect. However, a user should directly check a time, or the like, for the purpose of distributed iteration, which is troublesome. In addition, since the card has two surfaces (the front surface and the rear surface), in the case in which the number of items such as a question, a (association) hint, and an answer is three, two items should be inevitably put on one surface (for example, the question and the hint are written on the front surface and the answer is written on the rear surface).

(2) Digital Card Learning

This form is a form in which an analog card structure is converted into a digital manner as it is. Digital cards have a front surface and a rear surface and basically have a card overturning function and a classifying function, and a frequency of each card presented to a learner is adjusted using a timer or a Leitner system. However, since one card is seen once, a right of a user to freely browse or select a target to be learned is limited. Meanwhile, a list, or the like, may be seen through movement to a separate user interface, which is still troublesome.

(3) List Learning

Functions such as a classifying function through checking, an answer seeing function through overturning, and the like, are provided. Movement to another box or folder is generally made when the checking is performed (for example, movement to a ‘memorized word box’ is made when the checking is performed) and stay in another box or folder is made. Two boxes (a knowing box and an unknowing box) are made in a general case and several boxes are made in other cases to distribute classified items to the respective boxes. However, the user should search for the respective boxes, which is troublesome.

### DISCLOSURE

### Technical Problem

An object of the present invention is to provide a method for implementing intelligent flash cards in a mobile device having a touch screen in which a learning concept such as a distributed iteration effect, or the like, is inherent, and a mobile device having a touch screen for implementing intelligent flash cards, in consideration of the problems described above.

Another object of the present invention is to induce a learner to be naturally motivated by intuitively presenting the respective indices (the number of times of iteration, a completion rate, and the like) to a user interface.

### Technical Solution

According to an exemplary embodiment of the present invention, a method for implementing intelligent flash cards in a mobile device having a touch screen includes: displaying cards of a first group in a scrollable scheme on the touch screen, the cards including an identifying element in which the number of times of memorization iteration is visually displayed; detecting a touch event for a first region of a specific card selected among the cards of the first group; comparing the number of times of memorization iteration with the pre-stored reference number of times of completion when the touch event is detected; and excluding the specific card from the first group, changing the specific card into a card of a second group having an attribute distinguished from that of the cards of the first group, and adding the changed card to the second group in the case in which the number of times of the memorization iteration is smaller than the pre-stored reference number of times of the completion, and excluding the specific card from the first group, changing the specific card into a card of a third group having an attribute distinguished from that of the card of the first group and the card of the second group, and adding the changed card to the third group in the case in which the number of times of the memorization iteration is the same as the pre-stored reference number of times of the completion.

The method for implementing intelligent flash cards in a mobile device having a touch screen may further include providing different effect sounds through an audio output unit in the case of changing the specific card into a form of the card of the second group and adding the changed card to the second group or changing the specific card into a form of the card of the third group and adding the changed card to the third group or in the case of excluding a card of which an elapse time is a predetermined time or more among the cards of the second group from the second group, changing the card into a form of the first group, and adding the changed card to the first group.

The method for implementing intelligent flash cards in a mobile device having a touch screen may further include: starting the elapse of a time from a point in time in which each of cards belonging to the second group is added to the second group; and excluding a card of which an elapse time is a predetermined time or more among the cards of the second group from the second group, changing the card into a form of the first group, and adding the changed card to the first group.

The method for implementing intelligent flash cards in a mobile device having a touch screen may further include: detecting whether or not a touch event for a predetermined time or more for the first region of a card belonging to the first group or the second group is present; and excluding the card of which the touch event for the predetermined time or more for the first region is present from the first group or the second group, changing the card into a card form of the third group, and adding the changed card to the third group.

The method for implementing intelligent flash cards in a mobile device having a touch screen may further include: detecting whether or not a touch event for a second region different from the first region of cards belonging to the first to third groups is present; and displaying additional information for the card of which the touch event for the second region is present.

The method for implementing intelligent flash cards in a mobile device having a touch screen may further include controlling the additional information to disappear after a predetermined time elapses.

The method for implementing intelligent flash cards in a mobile device having a touch screen may further include: detecting whether or not a touch event for the first region of a card belonging to the second group is present; and excluding the card of which the touch event for the first region is present from the second group, changing the card into a card of the first group, and adding the changed card to the first group.

The card of the first group, the card of the second group, and the card of the third group may be displayed to be distinguished from each other by drawings or base colors.

The card of the first group, the card of the second group, and the card of the third group may be displayed to be distinguished from each other by positions.

The cards of the first to third groups may be collected and positioned in the respective groups, such that the cards of the first to third groups are displayed to be distinguished from each other.

The second group may be displayed to be positioned below the first group, and the third group may be displayed to be positioned below the second group.

The method for implementing intelligent flash cards in a mobile device having a touch screen may further include displaying a first display unit displaying a current total number of cards of the first group, a second display unit displaying a current total number of cards of the second group, and a third display unit displaying a current total number of cards of the third group.

The method for implementing intelligent flash cards in a mobile device having a touch screen may further include: detecting whether or not a touch event for the first to third display units is present; and moving a screen to the first to third groups corresponding to the corresponding first to third display units in the case in which the touch event for the first to third display units is present.

The method for implementing intelligent flash cards in a mobile device having a touch screen may further include: detecting whether or not a touch event for the first to third display units is present; and collecting and displaying the cards of the first to third groups corresponding to the corresponding first to third display units in the case in which the touch event for the first to third display units is present.

The method for implementing intelligent flash cards in a mobile device having a touch screen may further include: detecting whether or not a touch event in a downward direction that is in parallel with a scroll direction is present at the uppermost end of the first group; and providing an edition screen for creating a new card in the case in which the touch event in the downward direction is present.

The method for implementing intelligent flash cards in a mobile device having a touch screen may further include: detecting whether or not a touch event in a leftward or rightward direction perpendicular to a scroll direction is present for cards belonging to the first to third groups; and providing a screen for editing the card in the case in which the touch event in the leftward or rightward direction perpendicular to the scroll direction is present.

The card of the first group may include a visual or auditory attribute symbolizing air, the card of the second group includes a visual or auditory attribute symbolizing water, and the card of the third group includes a visual or auditory attribute symbolizing earth.

According to another exemplary embodiment of the present invention, a method for implementing intelligent flash cards in a mobile device having a touch screen includes: displaying cards of a first group in a scrollable scheme on the touch screen, the cards including an identifying element in which the number of times of memorization iteration is visually displayed; detecting a touch event for a first region of a specific card selected among the cards of the first group; excluding the specific card from the first group, changing the specific card into a card of a second group having an attribute distinguished from that of the card of the first group, and adding the changed card to the second group when the touch event is detected; starting the elapse of a time from a point in time in which each of cards belonging to the second group is added to the second group; and excluding a card of which an elapse time is a predetermined time or more among the cards of the second group from the second group, changing the card into a form of the first group, and adding the changed card to the first group.

According to still another exemplary embodiment of the present invention, a mobile device having a touch screen for implementing intelligent flash cards includes: the touch screen; and a control unit controlling a user interface displayed on the touch screen, wherein the control unit performs a control to display cards of a first group in a scrollable scheme on the touch screen, the cards including an identifying element in which the number of times of memorization iteration is visually displayed, performs a control to detect a touch event for a first region of a specific card selected among the cards of the first group through the touch screen, compares the number of times of memorization iteration with the pre-stored reference number of times of completion when the touch event is detected, and performs a control to exclude the specific card from the first group, change the specific card into a card of a second group having an attribute distinguished from that of the cards of the first group, and add the changed card to the second group in the case in which the number of times of the memorization iteration is smaller than the pre-stored reference number of times of the completion, and exclude the specific card from the first group, change the specific card into a card of a third group having an attribute distinguished from that of the card of the first group and the card of the second group, and add the changed card to the third group in the case in which the number of times of the memorization iteration is the same as the pre-stored reference number of times of the completion.

According to yet still another exemplary embodiment of the present invention, a mobile device having a touch screen for implementing intelligent flash cards includes: the touch screen; and a control unit controlling a user interface displayed on the touch screen, wherein the control unit performs a control to display cards of a first group in a scrollable scheme on the touch screen, the cards including an identifying element in which the number of times of memorization iteration is visually displayed, performs a control to detect a touch event for a first region of a specific card selected among the cards of the first group through the touch screen, performs a control to exclude the specific card from the first group, change the specific card into a card of a second group having an attribute distinguished from that of the card of the first group, and add the changed card to the second group when the touch event is detected, performs a control to check the elapse of a time from a point in time in which each of cards belonging to the second group is added to the second group, and performs a control to exclude a card of which a checked elapse time is a predetermined time or more among the cards of the second group from the second group, change the card into a form of the first group, and add the changed card to the first group.

According to yet still another exemplary embodiment of the present invention, a mobile device having a touch screen for implementing intelligent flash cards includes: the touch screen configured to display cards of a first group in a scrollable scheme, the cards including an identifying element in which the number of times of memorization iteration is visually displayed; a detecting unit detecting a touch event for a first region of a specific card selected among the cards of the first group through the touch screen; a comparing unit comparing the number of times of memorization iteration with the pre-stored reference number of times of completion when the touch event is detected; and a performing control unit excluding the specific card from the first group, changing the specific card into a card of a second group having an attribute distinguished from that of the cards of the first group, and adding the changed card to the second group in the case in which the number of times of the memorization iteration is smaller than the pre-stored reference number of times of the completion, and excluding the specific card from the first group, changing the specific card into a card of a third group having an attribute distinguished from that of the card of the first group and the card of the second group, and adding the changed card to the third group in the case in which the number of times of the memorization iteration is the same as the pre-stored reference number of times of the completion.

### Advantageous Effects

In the method for implementing intelligent flash cards in a mobile device having a touch screen according to the present invention, an item moving from a first group to a second group as an explicit memorization intention expression of a learner again moves to the first group after a predetermined time elapses in a program scheme, such that it is included in a target to be iteratively learned. In this process, the number of times of memorization iteration is visually displayed, thereby providing a distributed iteration user interface environment for effective memorization.

According to an exemplary embodiment of the present invention, an item, which is a current learning target, is disposed in the first group, an item memorized as current learning is disposed in the second group, and an item satisfying the predetermined number of times of memorization iteration, that is, an item reciprocating predetermined times between the first group and the second group is disposed in a third group, such that a form in which the item, which is the learning target, is disposed or moves is intuitive and the aim of learning (which is to send all of the items belonging to the first group to the third group) is clearly presented, thereby making it possible to improve a motivation effect.

According to an exemplary embodiment of the present invention, a phenomenon (forgetting) that knowledge input into a head escapes from the head with the passage of time is implemented by an intuitive user interface in which an item that is memorized and sunk in water (the second group) is floated to air (the first group) with the passage of time. In addition, as memorization is repeated, the item stays in the water for a longer time and is then floated, such that an effective distributed region is induced. In detail, the clear aim that all cards present in air (the first group) should be sent to earth (the third group) is presented, and an index (the number of items for each group) through which a current learning progress may be confirmed in real time is presented, thereby motivating learning.

### DESCRIPTION OF DRAWINGS

FIG. 1 is a block diagram of a mobile device 100 having a touch screen for implementing intelligent flash cards according to an exemplary embodiment of the present invention.

FIG. 2 is an illustrative perspective view of the mobile device 100 having a touch screen for implementing intelligent flash cards according to an exemplary embodiment of the present invention.

FIG. 3 is an image illustrating a form of a touch screen 116 of the mobile device outputting first user interface objects, for describing a method for implementing intelligent flash cards according to an exemplary embodiment of the present invention.

FIGS. 4A and 4B are user interface screens for describing a process of confirming an answer to a question by touching a second region 242 of a card.

FIGS. 5A to 5C are user interface screens for describing a process of performing a ‘memorization check’ for a specific card through a touch.

FIG. 6 is a conceptual diagram for describing a method for implementing intelligent flash cards in a mobile device having a touch screen according to an exemplary embodiment of the present invention.

FIGS. 7A to 7D are user interface screens for describing a process of performing a ‘memorization check’ for a specific card according to another exemplary embodiment of the present invention.

FIGS. 8A and 8B are user interface screens for describing a process of performing a ‘long touch’ for a specific card according to an exemplary embodiment of the present invention.

FIGS. 9A to 9D are user interface screens for describing a process of directly moving to a specific group by a touch for a display unit according to an exemplary embodiment of the present invention.

FIGS. 10A and 10B are user interface screens for describing a process of creating a new card through a touch at the uppermost end of a first group according to an exemplary embodiment of the present invention.

FIGS. 11A and 11B are user interface screens for describing a process of editing or deleting a card by a touch for a selected card according to an exemplary embodiment of the present invention.

FIGS. 12A to 12D are user interface screens for describing a process of displaying cards one by one by a touch for a selected card according to an exemplary embodiment of the present invention.

### BEST MODE

Hereinafter, a method for implementing intelligent flash cards in a mobile device having a touch screen and a mobile device having a touch screen for implementing intelligent flash cards according to an exemplary embodiment of the present invention will be described in detail with reference to the accompanying drawings. Terms “module” and “unit” for components used in the following description are used only in order to easily make the disclosure. Therefore, these terms do not have meanings or roles in themselves.

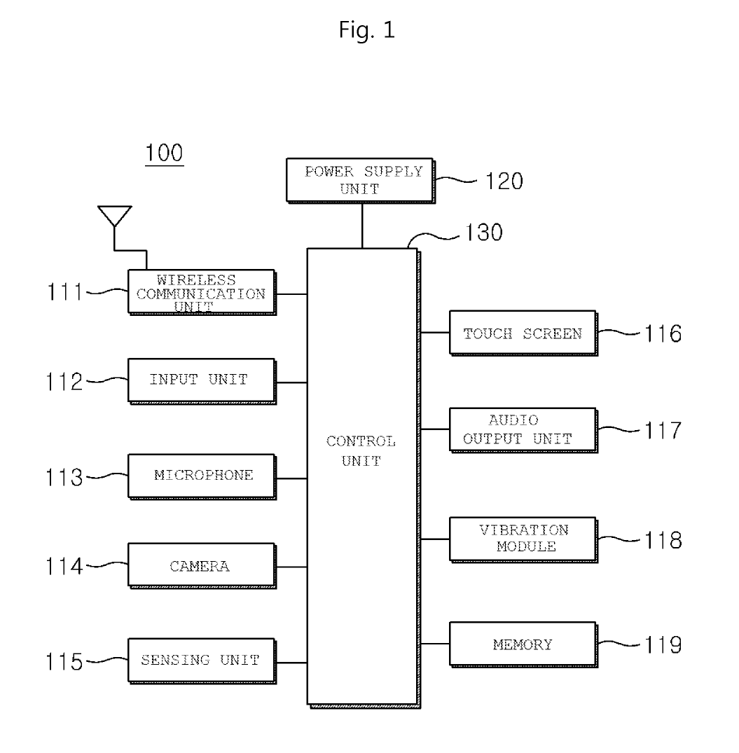

FIG. 1 is a block diagram of a mobile device 100 having a touch screen for implementing intelligent flash cards according to an exemplary embodiment of the present invention.

As illustrated in FIG. 1, the mobile device 100 may include a wireless communication unit 111, an input unit 112, a microphone 113, a camera 114, a sensing unit 115, a display 116, an audio output unit 117, a vibration module 118, a memory 119, a power supply unit 120, a control unit 130, and the like. However, the mobile device may be implemented by components more than the components illustrated in FIG. 1 or be implemented by components less than the component illustrated in FIG. 1.

The wireless communication unit 111 may include one or more components enabling wireless communication between the mobile device 100 and another wireless communication system or wireless communication between the mobile device 100 and a network in which another mobile device is positioned. For example, the wireless communication unit 111 may include a broadcasting receiving module, a mobile communication module, a wireless Internet module, a short range communication module, a position information module, and the like. A user may download or upload a question and an answer constituting contents of flash cards from or to the mobile device having a touch screen for implementing intelligent flash cards according to an exemplary embodiment of the present invention through the wireless communication unit 111.

The input unit 112 may receive a command for controlling an operation of the mobile device 100. The input unit 112 may adopt any tactile manner in which the user may perform manipulation while feeling tactile feeling.

An audio/video (A/V) input unit, which is to input an audio signal or a video signal, may include the microphone 113, the camera, 114, and the like.

The microphone 113 converts an audio of the user into an electrical signal in a call mode, or the like. In addition, the microphone 113 is used to receive an audio, or the like, in a recording mode, according to an exemplary embodiment of the present invention.

The camera 114 processes an image frame of a still image, a moving picture, or the like, obtained by an image sensor in a video call mode or a photographing mode. In addition, the processed image frame may be displayed on the display 116. The image frame processed in the camera 114 may be stored in the memory 119 or be transmitted to the outside through the wireless communication unit 111. Two or more cameras 114 may also be provided depending on an aspect of a configuration of the mobile device.

The sensing unit 115 senses inclination, an acceleration, an opened or closed state, or the like, of the mobile device. The sensing unit 115 may include a gyroscope device, an acceleration sensor, a micro electro-mechanical system (MEMS) component, or the like, in order to sense a change in an attitude, and another known sensor may be used.

An A/V output unit, which is to output an audio signal, a video signal, an alarm signal, or the like, may include the display 116, the audio output unit 117, the vibration module 118, and the like.

The display 16 displays and outputs information processed in the mobile device 100. For example, in the case in which the mobile device is in the call mode, the display 116 displays a user interface (UI) or a graphic user interface (GUI) related to a call. In addition, in the case in which the mobile device 100 is in the video call mode or the photographing mode, the display 116 displays photographed and/or received images, a UI, or a GUI. In the case in which the display 116 and a touch sensing sensor form a mutual layer structure to constitute a ‘touch screen’, the display 116 may be used as an input device as well as an output device. In a description to be provided below, the display 116 will be called a touch screen 116.

The audio output unit 117 outputs audio data received from the wireless communication unit 111 or stored in the memory 119 in a call signal receiving mode, a call mode or a recording mode, an audio recognizing mode, a broadcasting receiving mode, or the like. In addition, the audio output unit 117 outputs a sound signal related to a function (for example, a call signal reception sound, a message reception sound, or the like) performed in the mobile device 100. The audio output unit 117 may include a speaker, a buzzer, or the like.

The vibration module 118 outputs a signal for informing occurrence of an event of the mobile device 110. An example of the event occurring in the mobile device includes call signal reception, message reception, key signal input, touch input, and the like. The vibration module 118 may also output the signal for informing the occurrence of the event in a form other than an audio signal or a video signal. For example, the vibration module 118 may output a signal in a vibration form. In the case in which a call signal is received or a message is received, the vibration module 118 may output vibrations in order to inform that the call signal or the message has been received. Alternatively, in the case in which a key signal is input, the vibration module 118 may output vibrations as a feedback for the input of the key signal. The user may recognize that the event has occurred through the vibration output as described above. A signal for informing the occurrence of the event may also be output through the display 116 or the audio output unit 117.

The memory 119 may store recorded information therein or store a program for processing and control of the control unit 130 therein, and may perform a function of temporarily storing input/output data (for example, a phonebook, a message, a still image, a moving picture, and the like) therein, according to the present invention. In addition, the memory 119 may store data on various patterns of vibrations and sounds output at the time of inputting a touch onto the touch screen therein.

The power supply unit 120 receives external power or internal power by a control of the control unit 130 and supplies power required for operating the respective components.

The control unit 130 generally controls a general operation of the mobile device. For example, the control unit 130 performs related control and processing for an audio call, data communication, a video call, and the like. In addition, the control unit 130 may also include a multimedia module for reproducing a multimedia. The multimedia module may be implemented in the control unit 130 or be implemented separately from the control unit 130. The control unit 130 may perform pattern recognition processing so as to recognize each of an input or a picture drawing input conducted on the touch screen as a text and an image.

In addition, the control unit 130 may be in charge of a control function required for providing a user interface using the touch screen 116 and the audio output unit 117 according to an exemplary embodiment of the present invention. Detailed functions of the control unit 130 are related to methods such as a touch input, a screen output, an audio output, and the like, provided through the following description. The present invention relating to a method for implementing intelligent flash cards may be in a form of a storage medium in which a program or an application is stored or a transmittable form.

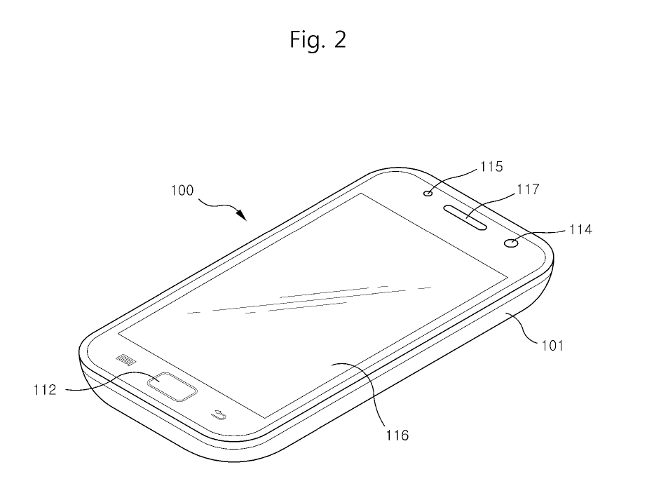

FIG. 2 is an illustrative perspective view of the mobile device 100 having a touch screen for implementing intelligent flash cards according to an exemplary embodiment of the present invention.

The mobile device having a touch screen according to an exemplary embodiment of the present invention may be one of various electronic apparatuses having a touch screen, such as a smart phone, a mobile communication terminal, a palmtop computer, a personal digital assistants (PDA), a smart pad, a tablet personal computer (PC), a language learning apparatus, and the like. FIG. 2 illustrates a mobile communication terminal 100 among them. The mobile communication terminal 100 includes a touch screen 116 disposed on a front surface thereof for the purpose of a touch input or an image output, and includes an input unit 112 for a key input or a touch input, an audio output unit 117, a camera 114, a sensor 115, and the like, disposed at one side of the touch screen 116. These components are provided for the purpose of input and output or a user interface, and are in charge of various functions of the mobile communication terminal 100, that is, a call, transmission and reception of a message, or implementation of an application. However, some of these function elements may be omitted and or new elements may be added to these function elements, depending on the mobile communication terminal 100.

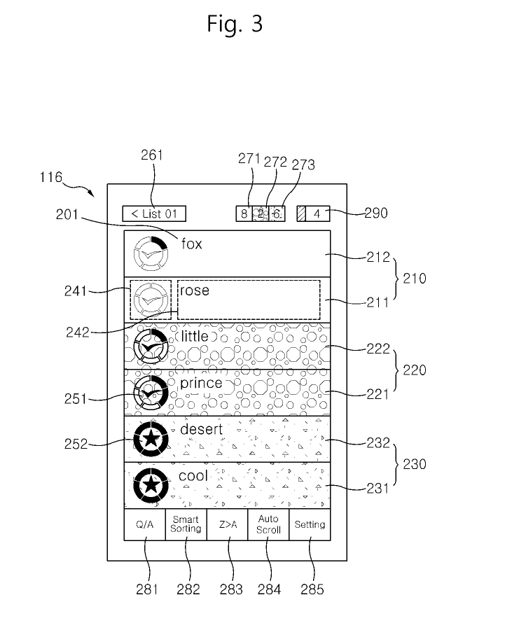

FIG. 3 is an image illustrating a form of a touch screen 116 of the mobile device outputting first user interface objects, for describing a method for implementing intelligent flash cards according to an exemplary embodiment of the present invention.

In FIG. 3, the touch screen 116 includes a plurality of user interface objects, which may be cards belonging to a first group 210, a second group 220, and a third group 230. The cards belonging to the respective groups are displayed in a scrollable scheme by a touch manipulation or a key input manipulation. A scroll by a ‘touch’ may be implemented by a user touching a card belonging to any group and dragging the card in an upward or downward direction. A scroll by the key input manipulation may be implemented by pressing or touching a key (including the input unit 112 or a keypad displayed on the touch screen 116) indicating a direction.

Cards 211, 212, 221, 222, 231, and 232 belonging to the first group 210, the second group 220, and the third group 230 may include a plurality of information. In the case in which the number of the plurality of information is two, when any one information is a ‘question’, the other information may be an ‘answer’, or vice versa. In the case in which the number of the plurality of information is three or more, the third information may mean an example sentence or a hint related to a question. The plurality of information may be exposed by various methods as in the case in which only the question is exposed, the case in which the answer is exposed, the case in which both of the question and the answer are exposed, or the like, by repeatedly touching or pressing a button 281 provided so as to select a display method. FIG. 3 illustrates the case in which an English word 201 is exposed.

The cards of the first group 210, the second group 220, and the third group 230 may be displayed to be visually or positionally distinguished from each other depending on groups to which they belong. In addition, the first group 210, the second group 220, and the third group 230 may also be displayed to symbolize specific regions. In detail, the first group 210 may be displayed to symbolize air, the second group 220 may be displayed to symbolize water, and the third group 230 may be displayed to symbolize earth. As an example, a base color of the first group 210 is displayed as a white based color, a base color of the second group 220 is displayed as a blue based color, and a base color of the third group 230 is displayed as a brown based color, thereby making it possible to be intuitively reminded of the air, the water, and the earth, respectively.

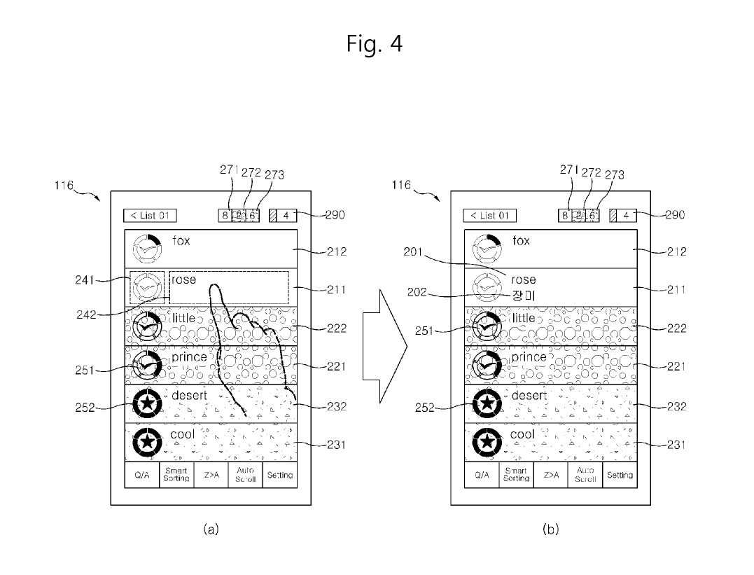

The cards 211, 212, 221, 222, 231, and 232 belonging to the first group 210, the second group 220, and the third group 230 may include a first region 241 and a second region 242 for displaying information or a touch input. The first region 241 is a region for inputting a state memorized for a corresponding card by a touch, and the second region 242 is a region for providing additional information in addition to a question for the card. An attention concentration of a learner is increased when contents (for example, a rose, [symbol] (Korean character)) that need to be memorized is presented to the learner in a state in which the contents partially are hidden rather than being entirely shown to the learner. That is, the learner makes an effort to remind of memory while jumping a question such as ‘what was this?’ on himself/herself even though a time is short. Generally, a hint or a question (for example, a rose) is written on a front surface of a flash card, and an answer (for example, [symbol] (Korean character)) is written on a rear surface of the flash card. It is general to remind of the answer after seeing the question, but it is also possible to remind of the question after seeing the answer. The answer is confirmed by overturning the card in a traditional analog flash card, but the answer is confirmed by performing a touch event such as a slide, a click, or the like, in the second region 242 in a digital flash card according to an exemplary embodiment of the present invention (see FIG. 4).

The cards belonging to the first to third groups 210 to 230 may include identifying elements 251 and 252 in which the number of times of memorization iteration is visually displayed. The identifying elements 251 and 252 may include a figure or a graphic meaning ‘check or ‘memorization completion (252)’ together with the number of times of memorization iteration. The identifying elements 251 and 252 may be disposed in the first region 241, the second region 242, or other positions. In the present exemplary embodiment, the case in which the identifying elements 251 and 252 are disposed in the first region 241 is illustrated.

A file name 261 may be displayed on an upper end of one side of the touch screen 116. A screen may be set to move to a page for managing a file, that is, performing edition such as selection, creation, download, deletion, and the like, of the file when the file name 261 is touched or tapped.

Buttons 271 to 273 displaying the numbers of cards of the first group 210, cards of the second group 220, and cards of the third group 230 may be disposed on one side of the touch screen 116. In an example of FIG. 3, in a current state, the number of cards of the first group 210 is eight, the number of cards of the second group 220 is two, and the number of cards of the third group 230 is six. The buttons 271 to 273 may have colors or shapes similar to background colors or images of the first to third groups 210 to 230 corresponding to the buttons. The buttons 271 to 273 may be utilized as shortcut buttons to selected specific groups. When a corresponding button is touched, a screen may move to the beginning of a corresponding group. In this case, the screen may approach a desired group more rapidly as compared with movement by a scroll.

Various user interface objects 281 to 285 displayed in a button form in which a touch input is possible so as to perform alignment of cards, implementation/change of functions, or the like, may be provided on one side of the touch screen 116. The user interface objects 281 to 285 may include a user interface object 281 displayed in a toggle button form so as to adjust a method for displaying information of the cards (for example, a method for determining whether to show both of a question (Q) of an answer (A) or to show only the question or the answer), a user interface object 282 displayed in a toggle button form so as to simply arrange words so that a recently learned word (a word that was intentionally touched by a user in order to confirm the answer) is positioned at the lowermost portion in a group and a non-learned word is positioned at the uppermost portion in the group, a user interface object 283 displayed in a toggle button form so as to change or select a rule for arranging the cards (for example, a rule for arranging items depending on an alphabet ascending order (A>Z) or an alphabet descending order (Z>A)), a user interface object 284 displayed in a toggle button form so that a scroll may automatically start or stop, a user interface object 285 provided in a toggle button form so that a change of a function or a mode may be adjusted, and the like.

A screen may be set to move to an Internet dictionary site in which words written on the cards are included in the case in which a touch for a predetermined time or more for the second region 242 of the cards 211, 212, 221, 222, 231, and 232 belonging to the first group 210, the second group 220, and the third group 230 is present. Due to characteristics of a flash card that may not include a lot of information at a time, cards are simply created on the basis of keywords, and reading of detailed information is left to selection of the user.

A display unit 290 displayed to provide the number of cards memorized on that day or a confirmation question solving function may be disposed on one side of the touch screen 116. The number of memorized cards may be directly confirmed through the display unit 290, and when the target number of words to be memorized is satisfied, a screen may be set to automatically move to a confirmation question solving page. The target number of words to be memorized on that day may be adjusted on Setting. The number of currently memorized words is 4, and when the target number (for example, 20) of words to be memorized is satisfied, a screen moves to the confirmation question solving page. The screen may be implemented to output a celebration message and a music (a fanfare) after the target number of words to be memorized today is accomplished and the screen moves to the confirmation question solving page. This directed effect may contribute to motivation of learning. With respect to items wrong in confirmation question solving, corresponding cards may be configured to return to original states, that is, consider that a defect is present in an autonomic memorization intention expression (check) and return to the first group 210 or the second group 220.

FIGS. 4A and 4B are user interface screens for describing a process of confirming an answer to a question by touching a second region 242 of a card. That is, in FIGS. 4A and 4B, when a second region 242 of a selected card 211 is touched (see FIG. 4A), the control unit senses a touch event to display an answer corresponding to a question, as illustrated in FIG. 4B. This answer may be controlled to disappear (flicker) after a predetermined time elapses. In addition, in the case in which the second region 242 is touched, a pronunciation of a word corresponding to the question may be reproduced as an audio simultaneously with displaying the answer corresponding to the question or without displaying the answer. The answer may appear below the question as illustrated in FIG. 4B, appear on a rear surface of the card while the card being overturned, or appear in a speech bubble in a screen.

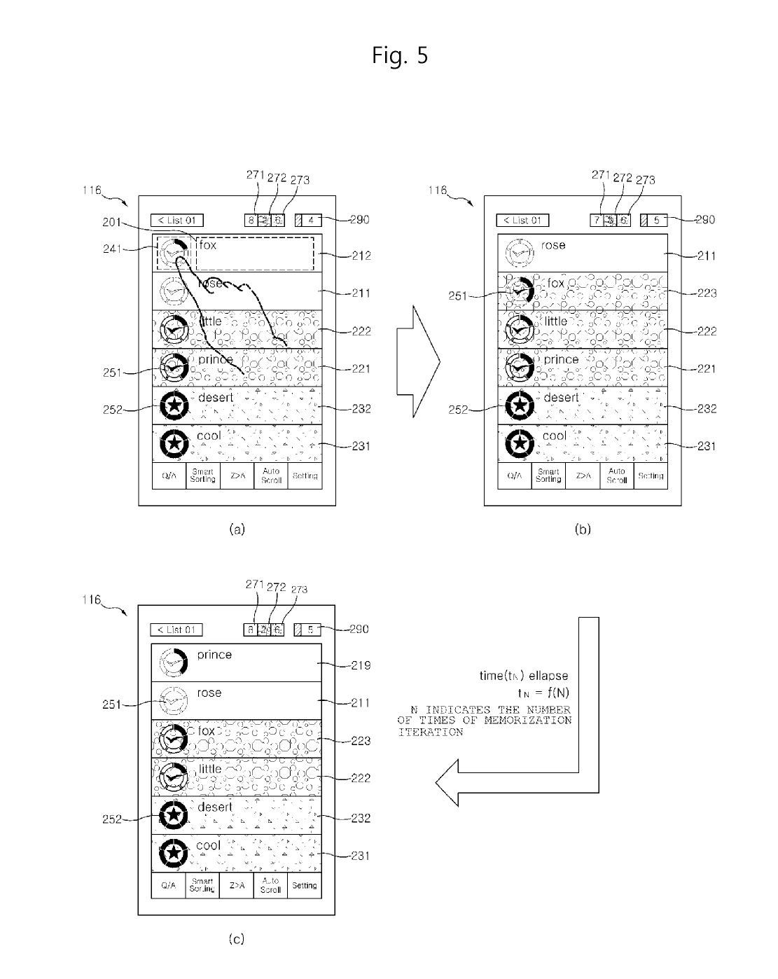

FIGS. 5A to 5C are user interface screens for describing a process of performing a ‘memorization check’ for a specific card through a touch.

The mobile device may include a detecting unit detecting a touch event for a first region 241 of a selected specific card 212 among cards of a first group 210 and a performing control unit excluding the specific card 212 from the first group 210, changing the specific card 212 into a card of a second group 220 having an attribute distinguished from those of the cards of the first group 210, and adding the changed card to the second group 220 when the touch event is detected. An identifying element 251 in which the number of times of memorization iteration is visually displayed may be disposed in the first region 241. As in the description in FIG. 3, the first to third groups 210 to 230 are distinguished from each other by attributes of cards. The attributes of the cards are related to visual factors, that is, colors, shapes, or sizes of the cards, and may also include positional factors. In FIG. 5, cards of the first group 210 are displayed by a color symbolizing air, cards of the second group 220 are displayed by a color symbolizing water, and cards of the third group 230 are displayed by a color symbolizing earth.

When the specific card 212, that is, ‘fox’ is memorized as illustrated in FIG. 5A, the user may touch the first region 241 of the specific card 212 in order to indicate that the memorization is completed. Therefore, as illustrated in FIG. 5B, the specific card 212 belonging to the first group 210 is excluded from the first group 210, and is changed into a card 223 having an attribute of the second group 220. In this case, the specific card 212 may move to be collected in the second group 220 or the specific card 212 may have only an attribute such as a color, or the like, belonging to the second group 220 and a position of the specific card 212 may be maintained. FIG. 5B illustrates an example of the former. Here, the specific card 223 changed into a card of the second group 220 is displayed in a state in which the number of times of memorization iteration of 1 that was displayed in the identifying element 251 before being changed is changed into 2.

A memorization check (a memorization intention expression for a corresponding item) may be distinguished from an action of confirming the answer (see FIG. 4). That is, when a learner confirms the answer but decides that he/she does not appropriately remind of a corresponding content or the content is very difficult, a process of performing a memorization check expression should be withheld. In the case in which the learner falsely performs a memorization check to know an item even though the learner does not know the item, he/her gets a question wrong in confirmation question solving automatically performed when the predetermined memorization number is satisfied. In this case, the corresponding item may be configured to return to a state in which it is not memorized.

The elapse of a time of the card belonging to the second group 220 starts from a point in time in which the card enters the second group 220. When a card of which an elapse time is a predetermined time or more is present among cards of the second group 220, the card is excluded from the second group 220, and is added to the first group 210 after an attribute of the card is changed into that of the first group 210. In detail, when a predetermined time elapses for the specific card 221 in FIG. 5B, the specific card 221 is changed into a card 219 that does not have an attribute of the second group 220, but has an attribute of the first group 210. When the specific card 221 is changed into a card of the first group 210 and belongs to the first group 210, it becomes a target to be memorized by the user. Whenever the cards are moved, buttons 271 to 273 indicating the number of cards in each group are changed. In addition, a similar effect may be implemented to be obtained by a manual manipulation of the user. That is, the mobile device may detect whether or not a touch event for a first region 241 of a card belonging to the second group 220 is present, and the card of which the touch event for the first region 241 of the card belonging to the second group 220 is present may be excluded from the second group 220 and may be changed into a card of the first group 210, and the changed card may be added to the first group 210.

In the present exemplary embodiment, a system allowing the card to finally arrive at the third group 230 by satisfying the number of times of memorization iteration while the card reciprocating between the first group 210 and the second group 220 has been illustrated. However, the card may also arrive at a final memorization completion estimation state while moving between the first group 210 and the second group 220 without the third group 230.

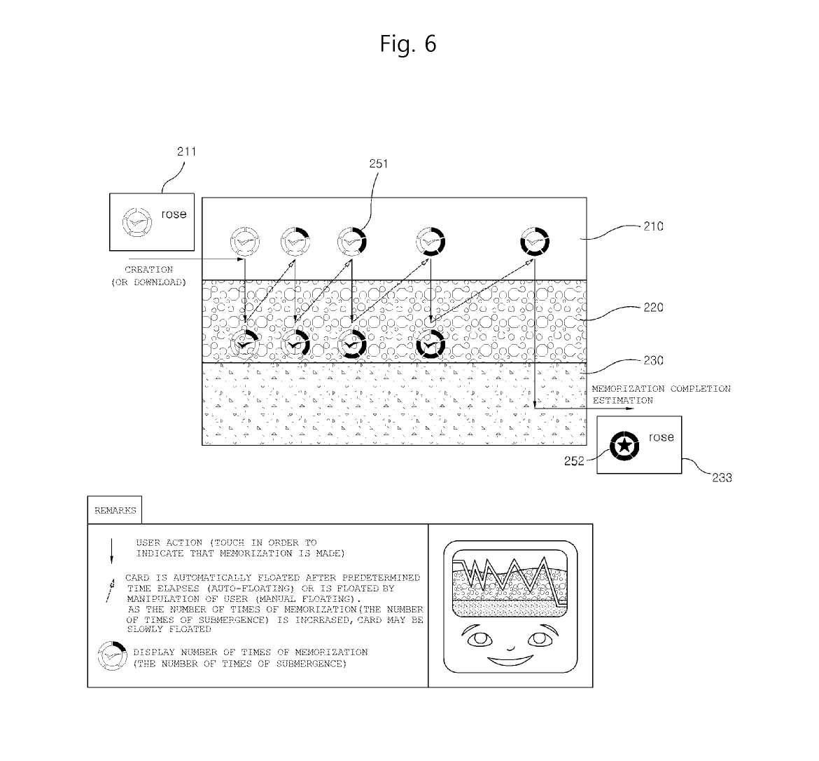

A memorization principle of the intelligent flash card as described above will be described with reference to FIG. 6. FIG. 6 is a conceptual diagram for describing a method for implementing intelligent flash cards in a mobile device having a touch screen according to an exemplary embodiment of the present invention.

Spaces or groups in which cards may be put may be represented by a first group 210 corresponding to air, a second group 220 corresponding to water, and a third group 230 corresponding to earth. A new card starts from an air region, and is sunk to a water region when the learner performs a check expression in order to indicate that memorization is completed. The sunk card is automatically floated to the air region after a predetermined time elapses, thereby providing a chance of a distributed review to the learner. The number of times of submergence (the number of times by which the card is sunk in water; the number of times of memorization by the learner) is displayed as a visual index, that is, an identifying element 251 in each item, and the larger the number of times of submergence, the longer the stay time in the water region before the card is floated. This is to implement a periodical time difference between reviews that becomes gradually large, which is a requirement of an effective distributed review. When a card of which the number of times of submergence is 4 is subjected to a check, it moves to an earth region (a memorization completion estimation region) rather than the water region. A separate mark 252 may also be used as a memorization completion expression for a card satisfying the reference number of times.

In the mobile device implemented by virtual cards moving between the air, the water, and the earth as described above, an auditory effect (for example, a sound occurring when water rises, a dull sound occurring when the card drops to earth, or the like) is provided together with a visual effect (for example, an animation indicating that water rises from the bottom) when the card is sunk or floated, thereby making it possible to increase intuition.

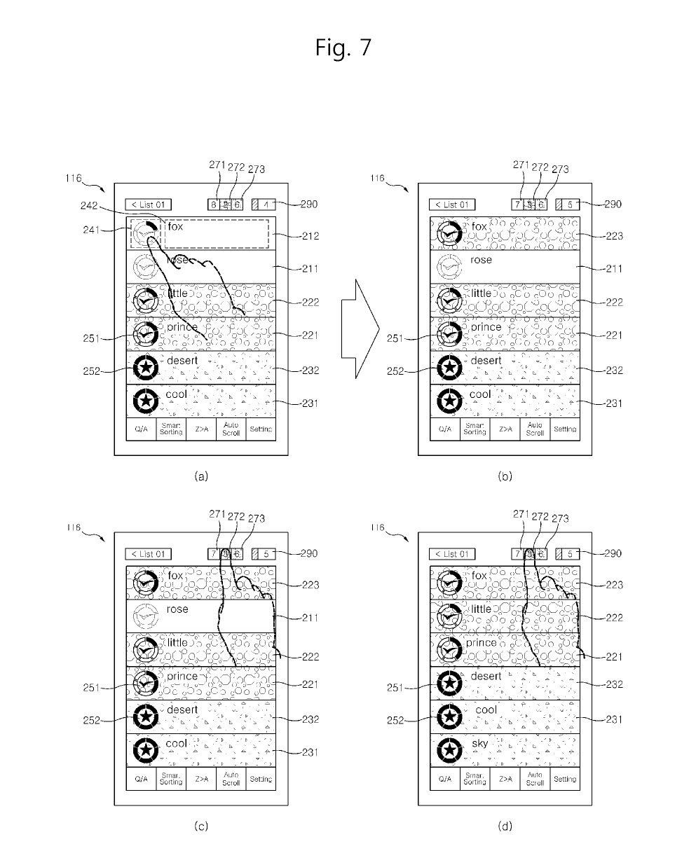

FIGS. 7A to 7D are user interface screens for describing a process of performing a ‘memorization check’ for a specific card according to another exemplary embodiment of the present invention.

When a user touches an identifying element 251 as an expression of completion of memorization of a specific card 212 as illustrated in FIG. 7A, the specific card may be configured so that a color of the specific card is changed into a color belonging to a second group 220 while a position of the specific card being maintained as illustrated in FIG. 7B. This process, which maintains an arrangement sequence or a position of the card and represents a memorization state of the specific card by an attribute of a group, may be utilized in order to indirectly confirm a memorization or learning state for an entire list.

When a display unit 272 of a specific group is selected even in the case in which cards corresponding to each group are spaced apart from each other as illustrated in FIG. 7C, cards of a group corresponding to the selected display unit 272 may be implemented to be collected and output as illustrated in FIG. 7D.

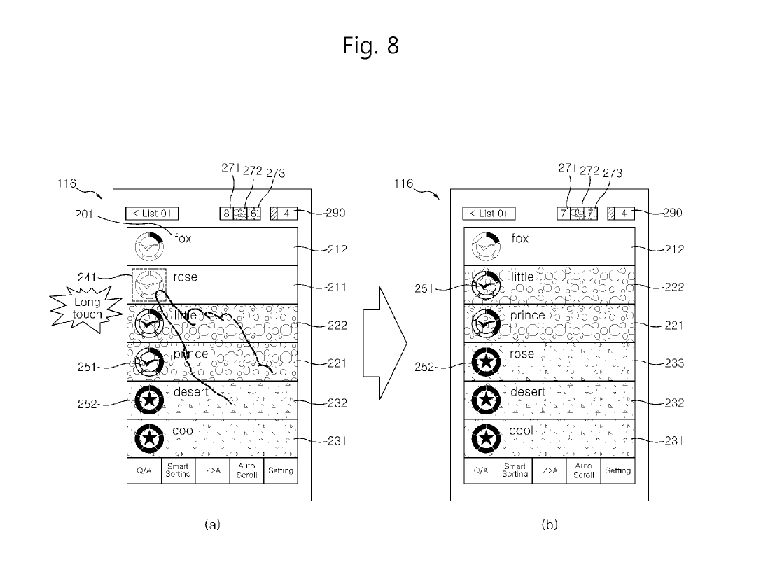

FIGS. 8A and 8B are user interface screens for describing a process of performing a ‘long touch’ for a specific card according to an exemplary embodiment of the present invention.

The mobile device may be configured to detect whether or not a touch event for a predetermined time or more for a first region 241 of a card belonging to a first group 210 or a second group 220 is present, exclude the card of which the touch event for the predetermined time or more (that may be called a ‘long touch’) for the first region is present from the first group 210 or the second group 220, change the card into a card form of the third group 230, and add the changed card to the third group 230. That is, as illustrated in FIG. 8A, in the case in which it is decided that a word ‘rose’ would be directly sent to a final destination without satisfying the predetermined number of times of iterative learning since it is too easy, a user may perform a touch for a predetermined time or more for the first region 241, thereby making it possible to directly move the word to the third group 230. In this case, an animation effect indicating that earth rises may also be output or an auditory effect may also be provided through an audio output unit. In this case, an expression of an identifying element 252 of a specific card 233 moving to the third group 230 may be changed so as to mean that the number of times of memorization iteration satisfies the reference number of times.

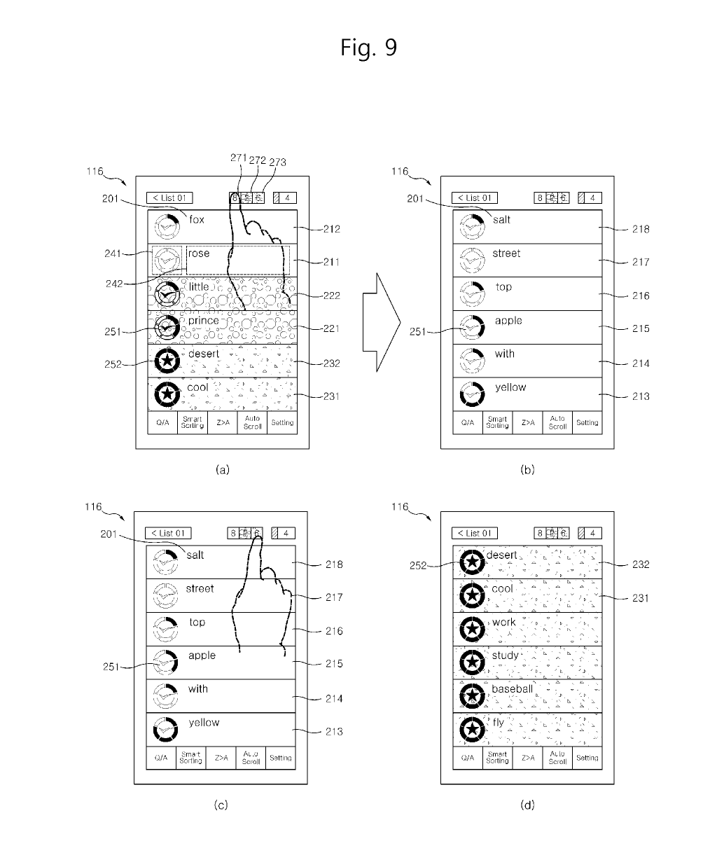

FIGS. 9A to 9D are user interface screens for describing a process of directly moving to a specific group by a touch for a display unit according to an exemplary embodiment of the present invention. That is, when a touch for a first display unit 271 among display units 271 to 273 is present as illustrated in FIG. 9A, cards 213 to 218 of a first group 210 corresponding to the first display unit 271 are displayed as illustrated in FIG. 9B. Likewise, when a touch for a third display unit 273 among the display units 271 to 273 is present as illustrated in FIG. 9C, cards 231 and 232 of a third group 230 corresponding to the third display unit 273 are displayed as illustrated in FIG. 9D.

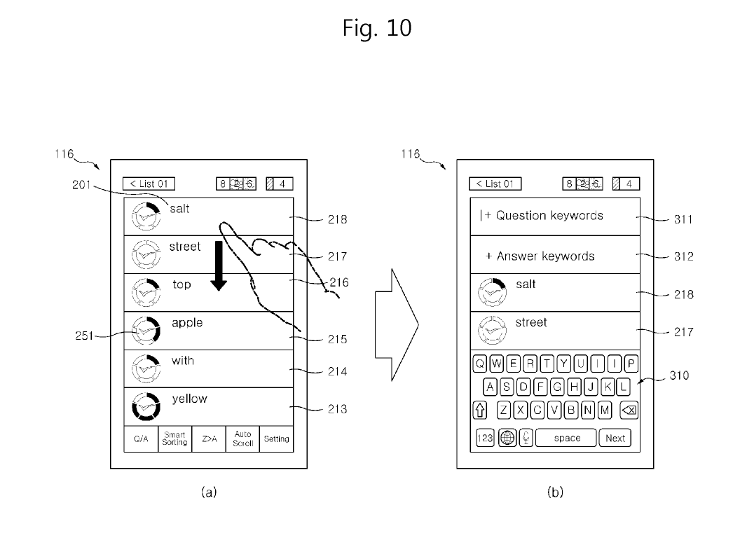

FIGS. 10A and 10B are user interface screens for describing a process of creating a new card through a touch at an upper end of a first group according to an exemplary embodiment of the present invention.

The mobile device illustrated in the present exemplary embodiment is configured to detect whether or not a touch event in a downward direction that is in parallel with a scroll direction is present at the uppermost end of the first group 210 and provide an edition screen for creating a new card in the case in which the touch event in the downward direction is present. As this edition screen, a keypad 310, a question input window 311, and an answer input window 312 may be displayed. This creation scheme coincides with intuition that intends to add a new item to the uppermost end of a list.

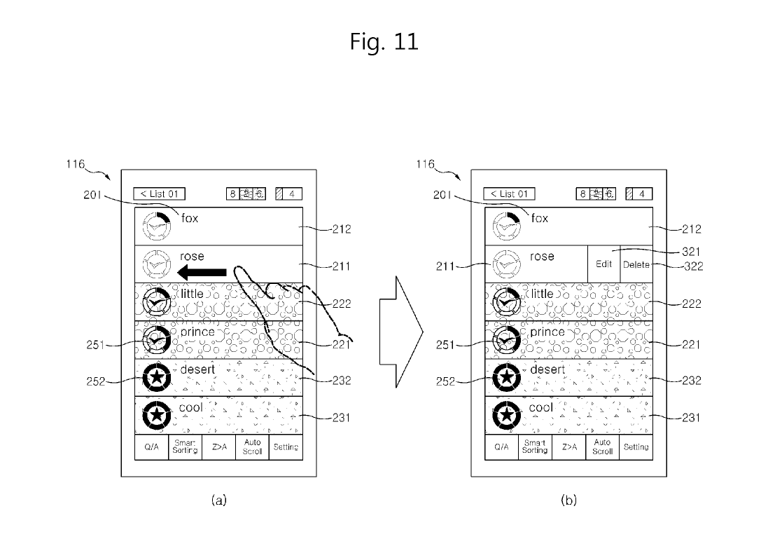

FIGS. 11A and 11B are user interface screens for describing a process of editing or deleting a card by a touch for a selected card according to an exemplary embodiment of the present invention.

The mobile device illustrated in the present exemplary embodiment is configured to detect whether or not a touch event in a leftward or rightward direction perpendicular to a scroll direction is present for cards belonging to first to third groups 210 to 230 and provide a screen for editing the card of which the touch event in the leftward or rightward direction perpendicular to the scroll direction is present. That is, in the case in which a continuous touch in the leftward or rightward direction perpendicular to the scroll direction is present for a specific card as illustrated in FIG. 11A, auxiliary creating buttons 321 and 322 for performing edition or deletion for the specific card are displayed. In the case in which the user touches the auxiliary creating buttons 321 and 322, a corresponding command is executed.

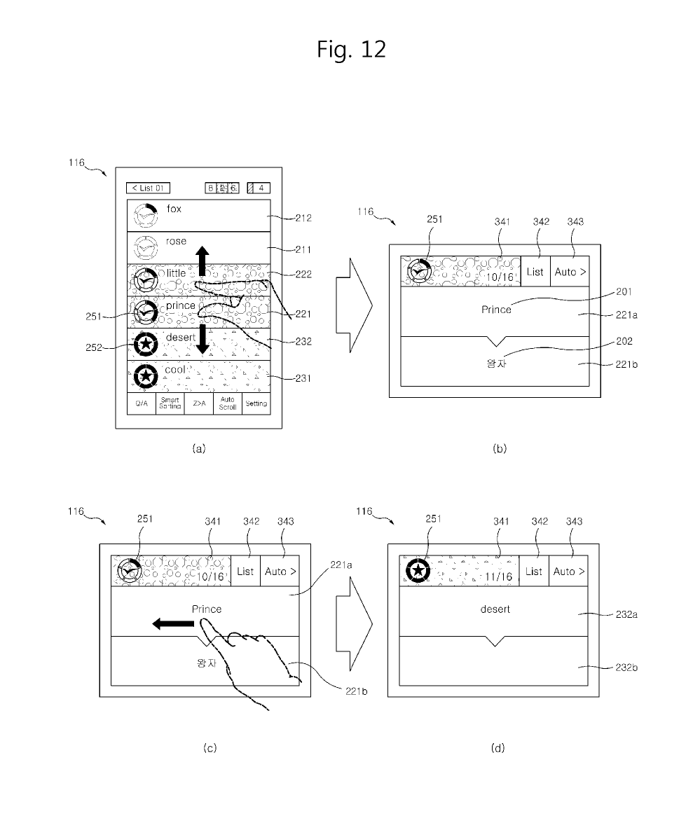

FIGS. 12A to 12D are user interface screens for describing a process of displaying cards one by one by a touch for a selected card according to an exemplary embodiment of the present invention.

An example in which the mobile device illustrated in the present exemplary embodiment displays a specific card 221 one by one (see FIG. 12B) in the case in which a touch is performed at a plurality of positions for the specific card 221 as if both fingers are splayed (see FIG. 12A) is illustrated. A touch may be performed as if both fingers pucker at the time of returning from an individual card mode into a list mode. In a situation as illustrated in FIG. 12B, an upper window 221a may be a region in which a question is displayed, and a lower window 221b may be a region in which an answer to the question is displayed. In the case in which a touch for the lower window 221b is present, an answer may be temporarily displayed.

When the specific card is slid leftward or rightward as illustrated in FIG. 12C, a card adjacent to the card is displayed. In the case in which a specific card before being handed over belongs to a second group 220, a sequence 341 of the specific card in an entire list, a group to which the specific card belongs, and whether a display method is automatic or manual may be displayed.

The method for implementing intelligent flash cards in a mobile device having a touch screen and the mobile device having a touch screen for implementing intelligent flash cards as described above are not limited to the configurations and the operation schemes according to the exemplary embodiments described above. The above-mentioned exemplary embodiments may be configured so that various modifications may be made by selective combinations of all or some of the respective exemplary embodiments.

1. A method for implementing intelligent flash cards in a mobile device including a touch screen, the method comprising:
displaying cards of a first group in a scrollable scheme on the touch screen, the cards including an identifying element in which a number of times of memorization iteration is visually displayed;
detecting a touch event in a first region of a specific card selected among the cards of the first group;
comparing the number of times of memorization iteration with a pre-stored number of times of completion when the touch event is detected; and
excluding the specific card from the first group, changing the specific card into a card of a second group having an attribute distinguished from that of the cards of the first group, and adding the changed card to the second group when the number of times of the memorization iteration is smaller than the pre-stored number of times of the completion, and excluding the specific card from the first group, changing the specific card into a card of a third group having an attribute distinguished from that of the card of the first group and the card of the second group, and adding the changed card to the third group when the number of times of the memorization iteration is equal to the pre-stored number of times of the completion.

2. The method of claim 1, further comprising:
starting an elapse of a time from a point in time in which each card belonging to the second group is added to the second group; and
excluding a card of which an elapse time of the card is equal to or greater than a predetermined time among the cards of the second group from the second group, changing the card into a form of the first group, and adding the changed card to the first group.

3. The method of claim 1, further comprising:
starting an elapse of a time from a point in time in which each card belonging to the second group is added to the second group; and
excluding a card of which an elapse time of the card is equal to or greater than a predetermined time among the cards of the second group from the second group, changing the card into a form of the first group, and adding the changed card to the first group.

4. The method of claim 1, further comprising:
detecting whether a touch event for a predetermined time or more for the first region of a card belonging to the first group or the second group is present; and
excluding the card of which the touch event for the predetermined time or more for the first region is present from the first group or the second group, changing the card into a card form of the third group, and adding the changed card to the third group.

5. The method for of claim 1, further comprising:
detecting whether a touch event in a second region different from the first region of cards belonging to the first to third groups is present; and
displaying additional information for the card of which the touch event in the second region is present.

6. The method of claim 5, further comprising controlling the additional information to disappear after a predetermined time elapses.

7. The method of claim 1, further comprising:
detecting whether a touch event in the first region of a card belonging to the second group is present; and
excluding the card of which the touch event in the first region is present from the second group, changing the card into a card of the first group, and adding the changed card to the first group.

8. The method of claim 1, wherein the card of the first group, the card of the second group, and the card of the third group are displayed to be distinguished from each other by drawings or base colors or positions.

9. (canceled)

10. The method of claim 1, wherein the cards of the first to third groups are collected and positioned in the respective groups, such that the cards of the first to third groups are displayed to be distinguished from each other.

11. The method of claim 10, wherein the second group is displayed to be positioned below the first group, and the third group is displayed to be positioned below the second group.

12. The method of claim 1, further comprising displaying a first display unit configured to display a current total number of cards of the first group, a second display unit configured to display a current total number of cards of the second group, and a third display unit configured to display a current total number of cards of the third group.

13. The method of claim 12, further comprising:
detecting whether a touch event for the first to third display units is present; and
moving a screen to the first to third groups respectively corresponding to the first to third display units when the touch event for the first to third display units is present.

14. The method of claim 12, further comprising:
detecting whether a touch event for the first to third display units is present; and
collecting and displaying the cards of the first to third groups respectively corresponding to the first to third display units when the touch event for the first to third display units is present.

15. The method for of claim 1, further comprising:
detecting whether a touch event in a downward direction that is in parallel with a scroll direction is present at an uppermost end of the first group; and
providing an edition screen for creating a new card when the touch event in the downward direction is present.

16. The method of claim 1, further comprising:
detecting whether a touch event in a leftward or rightward direction perpendicular to a scroll direction is present for cards belonging to the first to third groups; and
providing a screen for editing the card when the touch event in the leftward or rightward direction perpendicular to the scroll direction is present.

17. The method of claim 1, wherein the card of the first group includes a visual or auditory attribute symbolizing air, the card of the second group includes a visual or auditory attribute symbolizing water, and the card of the third group includes a visual or auditory attribute symbolizing earth.

18. A method for implementing intelligent flash cards in a mobile device having a touch screen, the method comprising:
displaying cards of a first group in a scrollable scheme on the touch screen, the cards including an identifying element in which a number of times of memorization iteration is visually displayed;
detecting a touch event for a first region of a specific card selected among the cards of the first group;
excluding the specific card from the first group, changing the specific card into a card of a second group having an attribute distinguished from that of the card of the first group, and adding the changed card to the second group when the touch event is detected;
starting an elapse of a time from a point in time in which each of cards belonging to the second group is added to the second group; and
excluding a card of which an elapse time of the card is equal to or greater than a predetermined time among the cards of the second group from the second group, changing the card into a form of the first group, and adding the changed card to the first group.

19. A mobile device including a touch screen for implementing intelligent flash cards, the mobile device comprising:
the touch screen; and
a control unit for controlling a user interface displayed on the touch screen, wherein the control unit is configured to:
control to display cards of a first group in a scrollable scheme on the touch screen, the cards including an identifying element in which a number of times of memorization iteration is visually displayed,
control to detect a touch event in a first region of a specific card selected among the cards of the first group through the touch screen,
compare the number of times of memorization iteration with a pre-stored number of times of completion when the touch event is detected, and
control to exclude the specific card from the first group, change the specific card into a card of a second group having an attribute distinguished from that of the cards of the first group, and add the changed card to the second group when the number of times of the memorization iteration is smaller than the pre-stored number of times of the completion, and exclude the specific card from the first group, change the specific card into a card of a third group having an attribute distinguished from that of the card of the first group and the card of the second group, and add the changed card to the third group when the number of times of the memorization iteration is equal to the pre-stored number of times of the completion.

20. A mobile device for implementing intelligent flash cards, comprising:
a touch screen; and
a control unit controlling a user interface displayed on the touch screen,
wherein the control unit is configured to:
control to display cards of a first group in a scrollable scheme on the touch screen, the cards including an identifying element in which a number of times of memorization iteration is visually displayed,
control to detect a touch event in a first region of a specific card selected among the cards of the first group through the touch screen,
control to exclude the specific card from the first group, change the specific card into a card of a second group having an attribute distinguished from that of the card of the first group, and add the changed card to the second group when the touch event is detected,
control to check an elapse of a time from a point in time when each card belonging to the second group is added to the second group, and
control to exclude a card of which the checked elapse time of the card is equal to or greater than a predetermined time among the cards of the second group from the second group, change the card into a form of the first group, and add the changed card to the first group.

21. A mobile device for implementing intelligent flash cards, comprising:
a touch screen configured to display cards of a first group in a scrollable scheme, the cards including an identifying element in which a number of times of memorization iteration is visually displayed;
a detecting unit configured to detect a touch event for a first region of a specific card selected among the cards of the first group through the touch screen;
a comparing unit configured to compare the number of times of memorization iteration with a pre-stored number of times of completion when the touch event is detected; and
a performing control unit configured to exclude the specific card from the first group, changing the specific card into a card of a second group having an attribute distinguished from that of the cards of the first group, and adding the changed card to the second group when the number of times of the memorization iteration is smaller than the pre-stored number of times of the completion, and excluding the specific card from the first group, changing the specific card into a card of a third group having an attribute distinguished from that of the card of the first group and the card of the second group, and adding the changed card to the third group when the number of times of the memorization iteration is equal to the pre-stored number of times of the completion.
